(19) United States
(12) Patent Application Publication
(10) Pub. No.: US 2022/0284353 A1
(43) Pub. Date: Sep. 8, 2022

(54) METHODS AND APPARATUS TO TRAIN A MACHINE LEARNING MODEL

(71) Applicant: Intel Corporation, Santa Clara, CA (US)

(72) Inventors: Hesham Mostafa, San Diego, CA (US); Casimir M. Wierzynski, La Jolla, CA (US)

(21) Appl. No.: 17/631,858

(22) PCT Filed: Sep. 23, 2020
(86) PCT No.: PCT/US2020/052253

§ 371 Date: Jan. 31, 2022

Related U.S. Application Data
(60) Provisional application No. 62/905,372, filed on Sep. 24, 2019.

(51) Int. Cl. G06N 20/20; G06N 7/00

(52) U.S. Cl. CPC G06N 20/20; G06N 7/005

(57) ABSTRACT

Methods, apparatus, systems, and articles of manufacture are disclosed to train a machine learning model. An example apparatus to generate adaptive hyper-parameters includes a model aggregator to, in response to obtaining at least one model trained using a first set of hyper-parameters of a probability distribution, generate a loss reduction, a hyper-parameter generator to, when the loss reduction satisfies a loss threshold, update the probability distribution and generate a second set of hyper-parameters using the updated probability distribution, and an interface to transmit the second set of hyper-parameters to a client.

### RELATED APPLICATION

This patent arises from an application claiming the benefit of U.S. Provisional Patent application Ser. No. 62/905,372, which was filed on Sep. 24, 2019. U.S. Provisional Patent application Ser. No. 62/905,372 is hereby incorporated herein by reference in its entirety. Priority to U.S. Provisional Patent application Ser. No. 62/905,372 is hereby claimed.

### FIELD OF THE DISCLOSURE

This disclosure relates generally to computing, and, more particularly, to methods and apparatus to train a machine learning model.

### BACKGROUND

Deep learning (DL) is an important enabling technology for the revolution currently underway in artificial intelligence, driving truly remarkable advances in fields such as object detection, image classification, speech recognition, natural language processing, and many more. In contrast with classical machine learning, which often involves a time-consuming and expensive step of manual extraction of features from data, deep learning leverages deep artificial neural networks (NNs), including convolutional neural networks (CNNs), to automate the discovery of relevant features in input data.

Training of a neural network is an expensive computational process. Such training often requires many iterations until an acceptable level of training error is reached. In some examples, millions of training iterations might be needed to obtain a model that performs well. Processed by a single entity, such iterations may take days, or even weeks, to complete. To address this, distributed training, where many different client devices are involved in the training process is used to distribute the processing to multiple clients.

### BRIEF DESCRIPTION OF THE DRAWINGS

FIG. 1 illustrates an example server-client environment including an example server and example clients.

FIG. 2 is an example block diagram of the server of FIG. 1.

FIG. 3 is a flowchart representative of example machine readable instructions which may be executed to implement the model trainer of FIG. 1 to train a model.

FIG. 4 is a flowchart representative of example machine readable instructions which may be executed to implement the server of FIG. 1 to generate example hyper-parameters.

FIG. 5 is a flowchart representative of example machine readable instructions which may be executed to implement the server of FIG. 1 to generate example hyper-parameters in the event the relative loss reduction satisfies a loss threshold.

FIG. 6 is a flowchart representative of example machine readable instructions which may be executed to implement the server of FIG. 1 to generate example hyper-parameters in the event the relative loss reduction does not satisfy a loss threshold.

FIG. 7 is a block diagram of an example processor platform structured to execute the instructions of FIG. 3 to implement the model trainer of FIG. 1.

FIG. 8 is a block diagram of an example processor platform structured to execute the instructions of FIGS. 4, 5, and/or 6 to implement the server of FIG. 1.

The figures are not to scale. Although the figures show layers and regions with clean lines and boundaries, some or all of these lines and/or boundaries may be idealized. In reality, the boundaries and/or lines may be unobservable, blended, and/or irregular. In general, the same reference numbers will be used throughout the drawing(s) and accompanying written description to refer to the same or like parts. As noted above, a first part can be above or below a second part with one or more of: other parts therebetween, without other parts therebetween, with the first and second parts touching, or without the first and second parts being in direct contact with one another. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein, “substantially real time” refers to occurrence in a near instantaneous manner recognizing there may be real world delays for computing time, transmission, etc. Thus, unless otherwise specified, “substantially real time” refers to real time +/−1 second.

### DETAILED DESCRIPTION

The amount of data included in a data set to train machine learning models is steadily increasing and, with this, privacy concerns associated with storing and managing such data sets are becoming more pressing. An approach to alleviate such concerns is to utilize a federated learning environment in which several clients collaboratively train a model independent of (e.g., without) disclosing their data to one another. Further, such approaches may employ synchronous federated learning environments in which training iterates in rounds. In such synchronous federated learning environments, a central party sends the latest version of the model to the clients at the beginning of each round. The clients (or a subset of clients) train the received model on their local datasets and then communicate the resulting models to the central party at the end of the round. The central party then aggregates the client models to obtain a new version of the model, which it then communicates to the clients in the next round. For example, the central party may aggregate the client models by averaging them.

However, such approaches often employ traditional hyper-parameter tuning schemes such as, for example, a random search method, a Bayesian method, etc. Such hyper-parameter tuning schemes often require several training iterations to evaluate the fitness of different hyper-parameters. Such an approach is impractical and computationally inefficient in a federated learning environment because a federated learning environment operates to minimize unnecessary communication.

Additionally, in some cases, an aggregation (e.g., averaging) of the model trained by each client may result in an inaccurate model. For example, if first data owned by a first client significantly differs from second data owned by a second client, an averaging of a first model trained by the first client with a second model trained by the second client may not properly classify the first data or the second data. Prior techniques using a single round of training (e.g., round length=1) may not be sufficient to produce an acceptable model.

Examples disclosed herein train a machine learning model across multiple computing devices (e.g., computers, servers, etc.) corresponding to multiple data owners (the “federation”). To reduce communication between clients and to reduce the number of interactions to train a model, examples disclosed herein include a server to select hyper-parameters at the beginning of each round to be sent to the clients. In examples disclosed herein, hyper-parameters may refer to any of a number of optimization steps to perform during a round of training, a learning rate of the model under training, etc. In examples disclosed herein, hyper-parameters are adapted, or modified, at the beginning of each round to reduce the inaccuracy of the aggregate model.

Examples disclosed herein include selecting hyper-parameters using a probability distribution corresponding to the space of all possible values of the hyper-parameters. In examples disclosed herein, the probability distribution includes parameters such as, for example, mean or precision. In some examples, the distribution (a) has a mean of zero, (b) is contained within a specified range, or (c) has the same scale in all dimensions to increase stability. However, any other parameters of the hyper-parameter distribution may be used. In some examples disclosed herein, the hyper-parameter space may be constructed such that each choice in the space is significantly different.

In examples disclosed herein, at the end of each round, the parameters of the distribution of hyper-parameters are updated by the server. A loss of the aggregate model (e.g., an aggregate model generated based on each of the model received from the clients) is generated to determine the inaccuracy of the model. In some examples, the server may maintain a small validation set representative of the data maintained by the clients on which the loss is determined. In other examples, the clients may evaluate the loss of the aggregate model on a portion of the client training data and send the loss to the server for the server to aggregate. In examples disclosed herein, the distribution parameters are updated using a weighted average reward based on a relative loss reduction.

In examples disclosed herein, the relative loss reduction is generated using the loss generated from a previous training round and the loss generated from a current training round. For example, if a first loss from a first training round is much higher than a second loss from a second training round, the second training round occurring after the first training round, the relative loss reduction may be higher than if the first loss was similar to the second loss. In some examples, the generation of a reward based on a relative loss reduction may use a baseline to weigh nearby (e.g., more recent) rewards more heavily than distant rewards. Once the relative loss reduction has been generated, the distribution parameters are updated. At the beginning of a next training round, the server identifies a new set of hyper-parameters using the distribution with the updated parameters.

During training of a model by a client, local representation matching may be used to discourage a client from learning representations in the model that are too specific to the data owned by the client. In other words, local representation matching may ameliorate a divergence of the trained model at a client from the global model provided by the server. At the beginning of a training round, the server sends model parameters to the clients. A client uses the model parameters to create a fixed model and a trained model. The trained model parameters are trained using iterations of a training algorithm, such as stochastic gradient descent. The client maintains a set of local parameters to map the activations in the trained model to activations in the fixed model. Both the trained model parameters and the local parameters are trained to reduce both the inaccuracy of the trained model on a set of sample inputs and a discrepancy (e.g., mean-squared difference) between the activations in the fixed model and activations in the trained model. At the end of training, the client sends the trained model parameters to the server.

In some examples, the activations of one layer in the fixed model are derived from the activations of the next layer of interest above in the trained model. For example, if a first layer in the fixed model corresponds to a second layer in the trained model, and a third layer in the fixed model connected to the output of the first layer corresponds to a fourth layer in the trained model connected to the output of the second layer, the activations of the first layer may be derived using the activations of the fourth layer. The activations of the fixed model are reconstructed from the activations of the trained model while the trained model is trained on data local to the client. In some examples, adaptive hyper-parameters and/or representation matching methods may increase the speed at which a federated learning model may be trained.

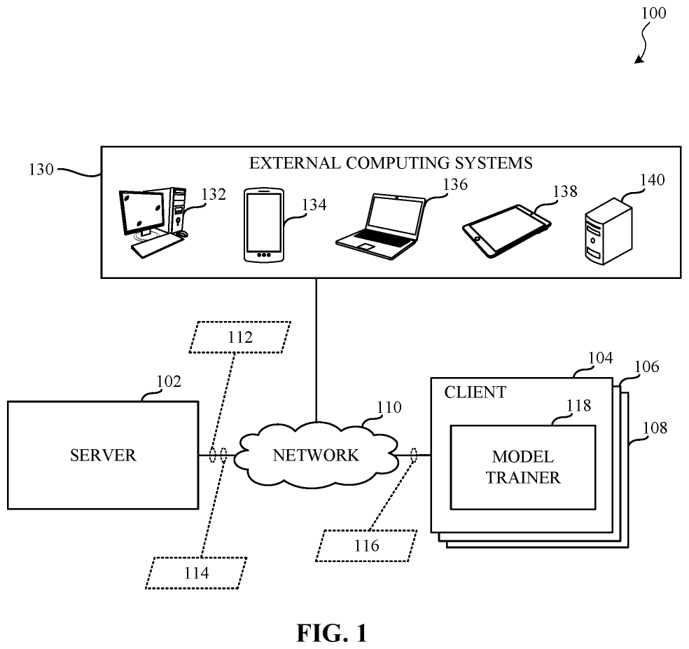

FIG. 1 illustrates an example server-client environment 100 including an example server 102 and example clients 104, 106, 108. In the example illustrated in FIG. 1, the server 102 and the clients 104, 106, 108 may communicate via an example network 110. In examples disclosed herein, the network 110 may be implemented using any suitable wired and/or wireless network (e.g., the Internet).

In FIG. 1, the server 102 is configured to aggregate models trained by example clients 104, 106, 108. In FIG. 1, the server 102 is configured to generate hyper-parameters 112 and example model parameters 114 to be sent to the clients 104, 106, 108. In examples disclosed herein, the hyper-parameters 112 include a learning rate and the number of optimization steps to execute during training of a model. However, any other parameters may be included in the hyper-parameters 112. In examples disclosed herein, the model parameters 114 are configuration parameters internal to a machine learning model. For example, a model parameter 114 may correspond to the weights to be implemented in a machine learning model.

Additionally, the server 102 is configured to aggregate example trained models 116 received from the clients 104, 106, 108 into an aggregate model. In examples disclosed herein, the server 102 is configured to, in response to obtaining the trained models 116 from the clients 104, 106, 108, generate a relative loss reduction. For example, the server 102 may generate the relative loss reduction by performing a weighted average of loss scores associated with each of the trained models 116. Such a relative loss reduction is compared to a threshold, by the server 102, to determine alternate hyper-parameters to send to the clients 104, 106, 108. In the example of FIG. 1, the hyper-parameters 112 may correspond to any iteration of the hyper-parameters transmitted to the clients 104, 106, 108.

In operation, the server 102 maintains a probability distribution over the space of hyper-parameters P(H|ψₜ) where H is the space of the hyper-parameters and ψₜ are the parameters of the probability distribution. For example, if the probability distribution P is a Gaussian distribution, then ψₜ would be a vector containing the mean and variance of the Gaussian distribution. At the beginning of a training round, the server 102 samples this probability distribution P to obtain a sample of the hyperparameters H. The server 102 then sends the latest version of the aggregated model, together with the hyper-parameter sample to the model trainer 118. The model trainer 118 uses the hyper-parameter sample to configure a training algorithm which is then used to train on a local dataset.

At the end of the round the model trainer 118 sends their trained model to the server 102. The server 102 then aggregate the trained model to obtain a new (e.g., updated) version of the aggregate model. The server 102 then evaluates the loss of the aggregate model. In some examples, the relative loss has improved by an amount larger than a threshold compared to the loss of the aggregate model from the previous round. In such examples, the parameters of the probability distribution ψₜ are adjusted by the server 102 to increase the probability of the hyper-parameter sample, thus increasing the likelihood that the hyper-parameter sample will be sampled again in future rounds.

In other examples, the relative loss did not improve by an amount larger than a threshold compared to the loss of the aggregate model from the previous round. In such examples, the parameters of the probability distribution ψₜ are adjusted by the server 102 to decrease the probability of the hyper-parameter sample, thus decreasing the likelihood that the hyper-parameter sample will be sampled again in future rounds.

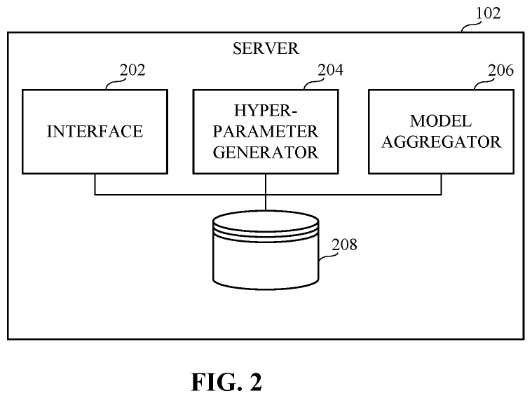

Detailed description of the server 102 is provided below, in connection with FIG. 2.

In the example of FIG. 1, the example clients 104, 106, 108 may be personal computers, tablets, smartphones, Internet appliances, wearable deices, and/or any other type of client computing device. In the illustrated example of FIG. 1, the clients 104, 106, 108 include an example model trainer 118. The example model trainer 118 is configured to access and/or otherwise obtain model parameters 114 from the server 102. Additionally, the model trainer 118 is configured to access and/or otherwise obtain hyper-parameters 112 from the server 102.

Using the hyper-parameters 112 and the model parameters 114, the model trainer 118 is configured to train a first machine learning model and a second machine learning model. The example model trainer 118 may train the first machine learning model and/or the second machine learning model using representation matching. To perform representation matching, at the beginning of a training round, the example model trainer 118 receives the latest version of the machine learning model from the server 102. The model trainer 118 then creates two copies of the machine learning model obtained from the server 102. In examples disclosed herein, a first copy of the machine learning model may be a fixed copy that is kept unchanged throughout the training round, and a second copy of the machine learning model may be a trainable copy that the model trainer 118 trains on its local dataset. Throughout training, the weights in the trainable copy will gradually be adjusted by the model trainer 118 to capture information in training data.

However, in some examples, a different model trainer may have significantly different training data, there is a risk that the trainable model copies in the different model trainer would diverge too much from each other. In examples disclosed herein, since all model trainers have the same fixed copy of the model, each model trainer operates to keep the trainable copy as close as possible to the fixed copy. By staying close to the fixed copy of the model, the trainable models in the different model trainer environments would not diverge too far from each other.

In examples disclosed herein, to keep the trainable copy of the model close to the fixed copy, while at the same time allowing the trainable copy to change to capture information in the training data, each model trainer seeks to minimize a representation matching loss. The representation matching loss is a difference in the representation of the local training data in the fixed model and the representation of the local training data in the trainable model. By keeping the representation matching loss low, different model trainers can keep their trainable model copies close to each other.

In examples disclosed herein, the first machine learning model is a fixed machine learning model, local to the corresponding client 104, 106, 108. In examples disclosed herein, the second machine learning model is a trainable machine learning model. In operation, the model trainer 118 of the corresponding clients 104, 106, 108 maintains a set of local parameters (θti) for use in calculating a loss. In examples disclosed herein, the loss includes (a) a standard training loss of the second machine learning model (e.g., the cross-entropy loss), and (b) a discrepancy and/or otherwise a representation matching loss (e.g., a mean squared difference). The model trainer 118 transmits the trained machine learning model (e.g., one of the trained models 116) and the corresponding loss to the server 102.

The model trainer 118 of the illustrated example of FIG. 1 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc.

The illustration of FIG. 1 further includes example external computing systems 130. In the illustrated example of FIG. 1, the external computing systems 130 are computing devices on which the hyper-parameters 112 and model parameters 114 is/are to be processed. In this example, the external computing systems 130 include an example desktop computer 132, an example mobile device 134 (e.g., a smartphone, an Internet-enabled smartphone, etc.), an example laptop computer 136, an example tablet 138 (e.g., a tablet computer, an Internet-enabled tablet computer, etc.), and an example server 140. In some examples, fewer or more computing systems than depicted in FIG. 1 may be used. Additionally or alternatively, the external computing systems 130 may include, correspond to, and/or otherwise be representative of any other type of computing device.

In some examples, one or more of the external computing systems 130 train and/or otherwise execute an example machine learning model to process the example hyper-parameters 112 and/or the example model parameters 114. For example, the mobile device 134 can be implemented as a cell or mobile phone having one or more processors (e.g., a CPU, a GPU, a VPU, an AI or neural-network (NN) specific processor, etc.) on a single system-on-a-chip (SoC) to process an AI/ML workload (e.g., the example hyper-parameters 112 and/or the example model parameters 114). For example, the desktop computer 132, the laptop computer 136, the tablet computer, and/or the server 140 can be implemented as computing device(s) having one or more processors (e.g., a CPU, a GPU, a VPU, an AI/NN specific processor, etc.) on one or more SoCs to process an AI/ML workload (e.g., the example hyper-parameters 112 and/or the example model parameters 114) using a machine learning model.

FIG. 2 is an example block diagram of the server 102 of FIG. 1. The server 102 includes an example interface 202, an example hyper-parameter generator 204, an example model aggregator 206, and an example data store 208.

In the example of FIG. 2, the interface 202 is configured to communicate with at least one of the clients 104, 106, 108 of FIG. 1. In this manner, the interface 202 can transmit the set of hyper-parameters 112 and/or the model parameters 114 to the clients 104, 106, 108 for use in training. Similarly, the interface 202 can obtain the machine learning model 116 and/or loss generated by the clients 104, 106, 108 when training. In the example of FIG. 2, the interface 202 is implemented using any suitable type of wired and/or wireless transceiver (e.g., a Wi-Fi radio, a hardware data bus, etc.).

The example hyper-parameter generator 204 generates an example hyper-parameter distribution (P) which includes various hyper-parameters (H) (e.g., the hyper-parameters 112) to be sent to the clients 104, 106, 108. In some examples disclosed herein, the hyper-parameter distribution (P) may be obtained and/or otherwise generated based on the following equation.

P=(H|ψₜ) Equation 1

In Equation 1, P refers to the hyper-parameter probability distribution, H refers to the hyper-parameters, and ψₜ refers to the parameterization of the probability distribution at the beginning of a training round t. Accordingly, at the beginning of a training round t, the hyper-parameter generator 204 selects and/or otherwise generates the hyper-parameters (H) (e.g., the hyper-parameters 112) from the hyper-parameter distribution (P). Such parameters may be transmitted by the interface 202 to be used by the clients 104, 106, 108 in training respective models (e.g., the trained models 116 of FIG. 1). In examples disclosed herein, the hyper-parameters (H) (e.g., the hyper-parameters 112) include a learning rate and the number of optimization steps to execute during training of a model. However, any other parameters may be included in the hyper-parameters (H) (e.g., the hyper-parameters 112).

In examples disclosed herein, the hyper-parameter generator 204 may, responsive to the model aggregator 206 determining an example relative loss reduction, generate and/or otherwise update the hyper-parameter probability distribution (P) by either increasing or decreasing the probability of a particular hyper-parameter (H) (e.g., at least one hyper-parameter of the hyper-parameters 112 previously sampled), thus increasing or decreasing the chance that the particular hyper-parameter (H) (e.g., at least one hyper-parameter of the hyper-parameters 112 previously sampled) will be sampled again. For example, in a first training round, the hyper-parameter generator 204 may generate and/or otherwise select first hyper-parameters (H₁) to be sent to the clients 104, 106, 108. In the event the resulting machine learning models obtained from the clients 104, 106, 108 results in a relative loss reduction not satisfying a loss threshold, the hyper-parameter generator 204 may generate second hyper-parameters (H₂) by decreasing the corresponding probability of the first hyper-parameters (H₁) in the hyper-parameter distribution (P). Alternatively, in the event the resulting machine learning models obtained from the clients 104, 106, 108 result in a relative loss reduction that satisfies a loss threshold, the hyper-parameter generator 204 may generate second hyper-parameters (H₂) by increasing the corresponding probability of the first hyper-parameters (H₁) in the hyper-parameter distribution (P). Description of the generation of the relative loss reduction is provided below in connection with the model aggregator 206. The example hyper-parameter generator 204 of the illustrated example of FIG. 1 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc.

The example model aggregator 206 aggregates the trained models received from the clients 104, 106, 108 into an aggregate model to generate a relative loss reduction (rₜ). In examples disclosed herein, the relative loss reduction (rₜ) refers to the loss of the aggregate model and may be determined using the below equation 2.

$${r}_{t} = \frac{{L}_{t + 1} - {L}_{t}}{\vert {L}_{t} \vert}$$

Equation 2

In equation 2, the variable (rₜ) refers to the relative loss reduction, the variable (L) correspond to the aggregate loss of the aggregate model, and the variable (t) correspond to the training round. In examples disclosed herein, the relative loss reduction (rₜ) is utilized to have a scale of rewards consistent through training rounds (t). The model aggregator 206 further indicates to the hyper-parameter generator 204 to either increase the probability or decrease the probability of a previously sampled hyper-parameter within the hyper-parameter distribution (P) based on whether the relative loss reduction (rₜ) satisfies a loss threshold. To determine whether the relative loss reduction (rₜ) satisfies a loss threshold, the model aggregator 206, at round (t), minimizes the following equation 3.

Jₜ= [symbol] _{P(h}_{ₜ}_{|ψ}_{ₜ}₎[rₜ] Equation 3

In equation 3, the variable (J) refers to the score-function. In examples disclosed herein, the model aggregator 206 may further perform a derivative function on the score-function (J) to update the parameterization (ψₜ). In examples disclosed herein, the loss threshold refers to a predetermined value which the model aggregator 206 compares to the score-function (J). In examples disclosed herein, the loss threshold may be any suitable value. Further, to update the parameterization (ψₜ), the model aggregator 206 may utilize the following equations 4 and 5.

∇₁₀₄ _{ₜ}Jₜ= [symbol] _{P(h}_{ₜ}_{|ψ}_{ₜ}₎[rₜ∇_{ψ}_{ₜ} log(P(hₜ|ψₜ))] Equation 4

∇₁₀₄ _{ₜ}Jₜ≈rₜ∇_{ψ}_{ₜ} log(P(hₜ|ψₜ)) where hₜ˜P(ₜ|ψₜ) Equation 5

In equations 4 and 5, the score-function (J) can be readily evaluated and utilized to update the parameterization ψₜ by the hyper-parameter generator 204. However, to reduce the variance, examples disclosed herein utilize a weighted average reward in an interval such as, for example, [t−Z, t+Z] centered around (t).

Thus, in an example operation, the hyper-parameter generator 204 may determine whether to increase or decrease the probability of the hyper-parameters (H) using the following equation 6.

ψₜ₋₁←ψₜ−η_{H}(rₜ−r̅ₜ)∇_{ψ}_{ₜ} log(P(hₜ|ψₜ)) Equation 6

where

$${\overline{r}}_{t} = {γ}_{Z} {Σ}_{{τ = t - Z}_{τ \neq Z}}^{τ = t + Z} ( Z + 1 - \vert τ - T \vert ) {r}_{τ}$$

In equation 6, the variable (η_{H}) refers to the learning rate and the variable (γ_{z}) refers to the normalizing constant. Accordingly, the hyper-parameter generator 204 weighs nearby rewards more heavily than distant rewards when calculating the baseline in round (t), therefore increasing or decreasing the probability of a previously sampled hyper-parameter within the hyper-parameters (H) based on whether the relative loss reduction (rₜ) satisfies a loss threshold.

In other examples disclosed herein, the hyper-parameter generator 204 may determine a causal version of equation 6 using the below equation 7.

ψₜ₋₁←ψₜ−η_{H}Σ_{τ-t=z}^{τ=t}(rₜ−\hat{r}ₜ)∇_{ψ}_{ₜ} log(P(hₜ|ψₜ)) Equation 7

where

$${\hat{r}}_{t} = \frac{1}{Z + 1} {\sum }_{τ = t - {Z}^{r} τ}^{τ = t}$$

The example model aggregator 206 of the illustrated example of FIG. 1 is implemented by a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)), graphics processing units (GPUs), etc.

In the example illustrated in FIG. 2, the data store 208 is configured to store the hyper-parameter distribution (P), the hyper-parameters (H), the trained models 116, the individual loss of the trained models, the relative loss reduction (rₜ) and/or any other suitable data set, metric, and/or data element utilized by the server 102. The example data store 208 of the illustrated example of FIG. 2 may be implemented by any device for storing data such as, for example, flash memory, magnetic media, optical media, etc. Furthermore, the data stored in the example data store 208 may be in any data format such as, for example, binary data, comma delimited data, tab delimited data, structured query language (SQL) structures, etc.

While an example manner of implementing the model trainer 118 of FIG. 1 is illustrated in FIG. 1 and an example manner of implementing the server 102 of FIG. 1 is illustrated in FIG. 2, one or more of the elements, processes and/or devices illustrated in FIGS. 1 and/or 2 may be combined, divided, re-arranged, omitted, eliminated and/or implemented in any other way. Further, the example model trainer 118 of FIG. 1, and/or the example interface 202, the example hyper-parameter generator 204, the example model aggregator 206, the example data store 208 and/or, more generally, the example server 102 of FIGS. 1 and/or 2 may be implemented by hardware, software, firmware and/or any combination of hardware, software and/or firmware. Thus, for example, any of the example model trainer 118 of FIG. 1, and/or the example interface 202, the example hyper-parameter generator 204, the example model aggregator 206, the example data store 208 and/or, more generally, the example server 102 of FIGS. 1 and/or 2 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example model trainer 118 of FIG. 1, and/or the example interface 202, the example hyper-parameter generator 204, the example model aggregator 206, the example data store 208 and/or, more generally, the example server 102 of FIGS. 1 and/or 2 is/are hereby expressly defined to include a non-transitory computer readable storage device or storage disk such as a memory, a digital versatile disk (DVD), a compact disk (CD), a Blu-ray disk, etc. including the software and/or firmware. Further still, the example model trainer 118 of FIG. 1 and/or the example server 102 of FIG. 1 may include one or more elements, processes and/or devices in addition to, or instead of, those illustrated in FIGS. 1 and/or 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

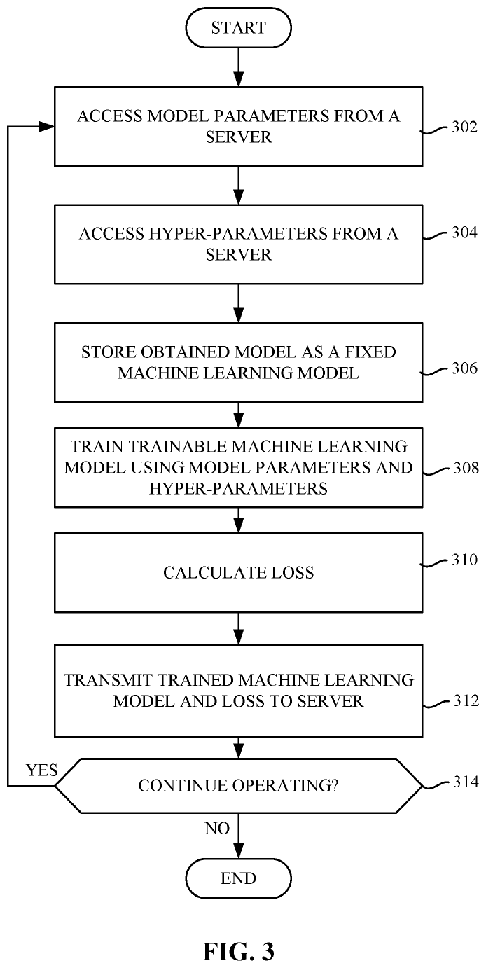

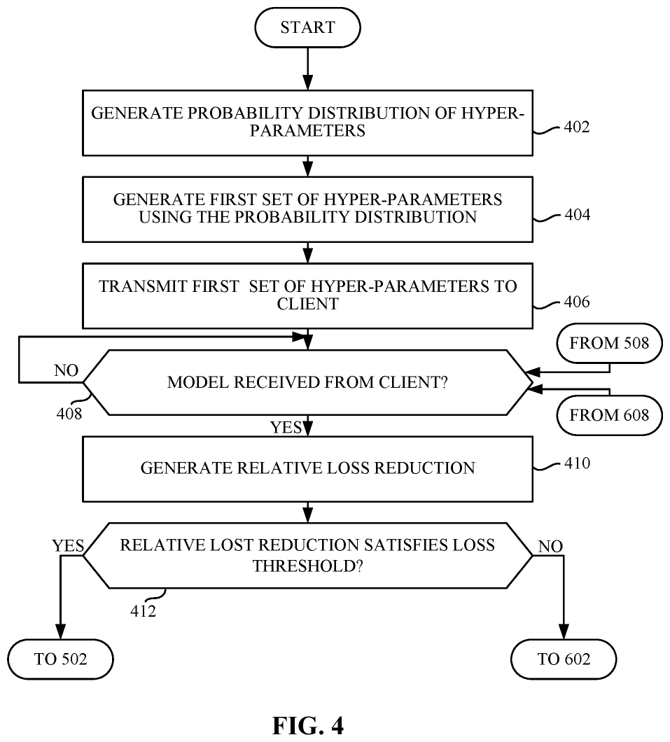

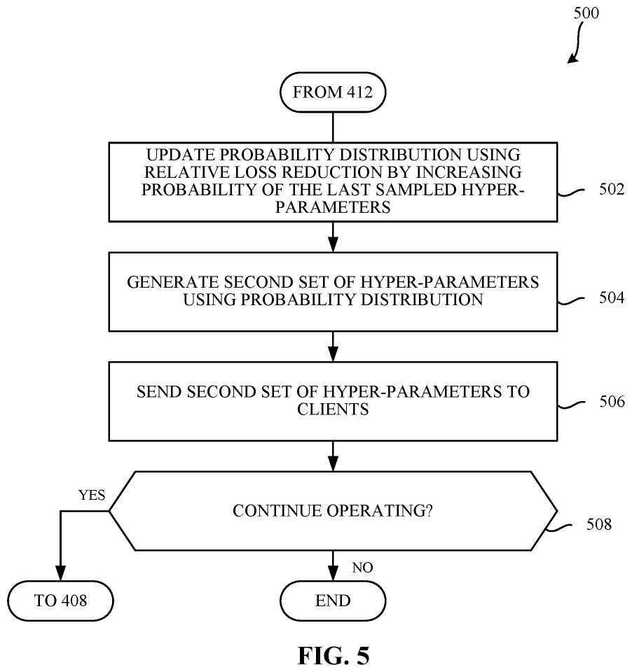

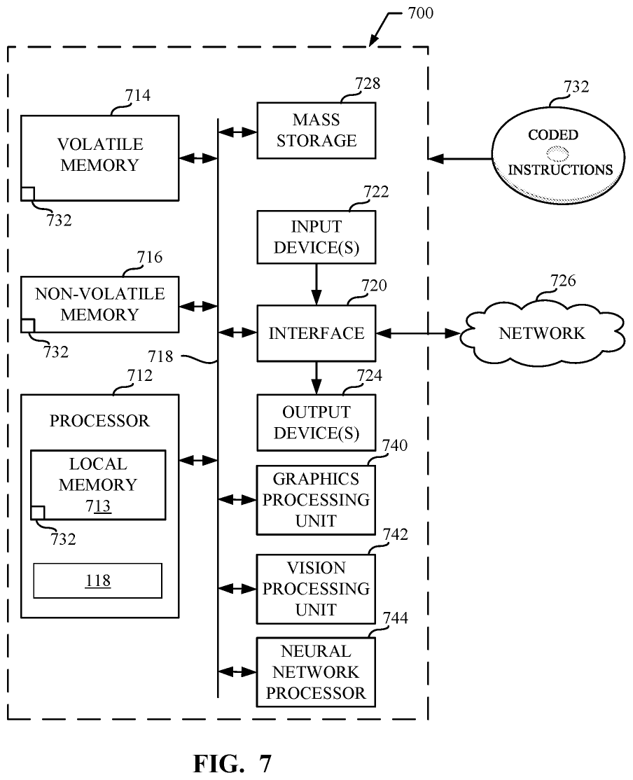

A flowchart representative of example hardware logic, machine readable instructions, hardware implemented state machines, and/or any combination thereof for implementing the model trainer 118 of FIG. 1 is shown in FIG. 3. Flowcharts representative of example hardware logic, machine readable instructions, hardware implemented state machines, and/or any combination thereof for implementing the server 102 of FIGS. 1 and/or 2 are shown in FIGS. 4, 5, and/or 6. The machine readable instructions may be one or more executable programs or portion(s) of an executable program for execution by a computer processor and/or processor circuitry, such as the processor 712, 812 shown in the example processor platform 700, 800 discussed below in connection with FIGS. 7 and/or 8. The program may be embodied in software stored on a non-transitory computer readable storage medium such as a CD-ROM, a floppy disk, a hard drive, a DVD, a Blu-ray disk, or a memory associated with the processor 712, 812, but the entire program and/or parts thereof could alternatively be executed by a device other than the processor 712, 812 and/or embodied in firmware or dedicated hardware. Further, although the example program is described with reference to the flowcharts illustrated in FIGS. 3, 4, 5, and/or 6, many other methods of implementing the example model trainer 118 and/or the server 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 3, 4, 5, and/or 6 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a,” “an,” “first,” “second,” etc.) do not exclude a plurality . The term “a” or “an” entity, as used herein, refers to one or more of that entity. The terms “a” (or “an”), “one or more,” and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions 300 which may be executed to implement the model trainer 118 of FIG. 1 to train a model.

At block 302, the example model trainer 118 is configured to access and/or otherwise obtain model parameters 114 (FIG. 1) from a server 102 (FIG. 1). (Block 302). Additionally, the model trainer 118 is configured to access and/or otherwise obtain hyper-parameters 112 (FIG. 1) from the server 102. (Block 304).

At block 306, the model trainer 118 trains stores the model obtained from the server 102 as a fixed machine learning model. (Block 306). For example, the model trainer 118 may store the fixed machine learning model for use in calculating the representation matching loss.

At block 308, the model trainer 118 trains a trainable machine learning model using the model parameters 114 and the hyper-parameters 112. (Block 308). For example, the model trainer 118 may train the trainable machine learning model using representation matching. In some examples disclosed herein, the trainable machine learning model may be the same model as the fixed machine learning model. In such examples, the fixed machine learning model is stored by the model trainer 118 for use in a representation matching calculation, while the trainable machine learning model is used by the model trainer 118 in training.

At block 310, the model trainer 118 calculates a loss of the trainable model. (Block 310). For example, the model trainer 118 maintains a set of local parameters (θti) for use in calculating a loss. In examples disclosed herein, the loss includes (a) a standard training loss of the second machine learning model (e.g., the cross-entropy loss), and (b) a discrepancy and/or otherwise a representation matching loss (e.g., a mean squared difference).

At block 312, the model trainer 118 transmits the trained machine learning model (e.g., one of the trained models 116) and the corresponding loss to the server 102. (Block 312)

At block 314, the model trainer 118 determines whether to continue operating. (Block 314). In the event the model trainer 118 determines to continue operating (e.g., the control of block 314 returns a result of YES), the model trainer 118 executes the instructions represented by block 302. In examples disclosed herein, the model trainer 118 may determine to continue operating in the event additional hyper-parameters are obtained from the server 102.

Alternatively, in the event the model trainer 118 determines not to continue operating (e.g., the control of block 314 returns a result of NO), the process ends. In examples disclosed herein, the model trainer 118 may determine not to continue operating in the event no additional hyper-parameters are available from the server, a loss of power occurs, etc.

FIG. 4 is a flowchart representative of example machine readable instructions 400 which may be executed to implement the server 102 of FIG. 1 to generate example hyper-parameters 112.

At block 402, the server 102 (FIG. 1) generates a probability distribution of hyper-parameters. (Block 402). In examples disclosed herein, the example hyper-parameter generator 204 (FIG. 2) generates an example hyper-parameter distribution (P) which includes various hyper-parameters (H) (e.g., the hyper-parameters 112). In some examples disclosed herein, the hyper-parameter distribution (P) may be obtained and/or otherwise generated by the hyper-parameter generator 204 using instructions represented by equation 1 above.

At block 404, the server 102 generates a first set of hyper-parameters using the probability distribution. (Block 404). In examples disclosed herein, the hyper-parameter generator 204 selects and/or otherwise generates an example first set of hyper-parameters (H) (e.g., the hyper-parameters 112) from the hyper-parameter distribution (P).

At block 406, the example server 102 transmits the set of hyper-parameters to the client(s) 104, 106, 108. (Block 406). In examples disclosed herein, the interface 202 is configured to communicate with at least one of the clients 104, 106, 108 to transmit the hyper-parameters 112 for use when training.

At block 408, the example server determines whether a model is received from the client(s) 104, 106, 108. (Block 408). In examples disclosed herein, the interface 202 is configured to determine whether the model (e.g., the machine learning model 116) is obtained from the client(s) 104, 106, 108.

In the event the interface 202 determines that a model is not obtained from the client(s) 104, 106, 108 (e.g., the control of block 408 returns a result of NO), the process waits. Alternatively, in the event the interface 202 determines that a model is obtained from the client(s) 104, 106, 108 (e.g., the control of block 408 returns a result of YES), the server 102 generates the relative loss reduction. (Block 410). In some examples disclosed herein, the example model aggregator 206 (FIG. 2) aggregates the trained model(s) received from the clients 104, 106, 108 into an aggregate model to generate a relative loss reduction (rₜ). In examples disclosed herein, the relative loss reduction (rₜ) refers to the loss of the aggregate model and may be determined using the above equation 2.

At block 412, the server 102 determines whether the relative loss reduction satisfies a loss threshold. (Block 312). In examples disclosed herein, the model aggregator 206 may determine whether the relative loss reduction satisfies a loss threshold using, for example, instructions represented in equations 3, 4, 5, 6, and/or 7.

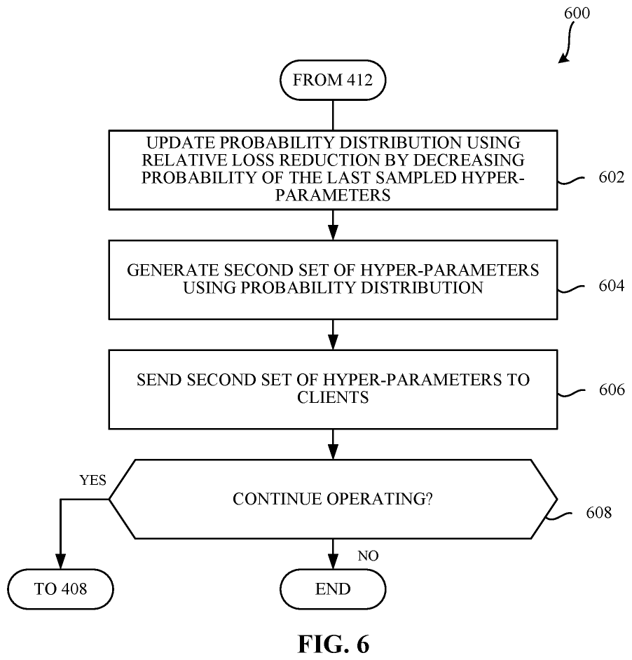

In the event the model aggregator 206 determines that the relative loss reduction satisfies the loss threshold (e.g., the control of block 412 returns a result of YES), control proceeds to block 502 of FIG. 5. Alternatively, in the event the model aggregator 206 determines that the relative loss reduction does not satisfy the loss threshold (e.g., the control of block 412 returns a result of NO), the process proceeds to block 602 of FIG. 6.

FIG. 5 is a flowchart representative of example machine readable instructions 500 which may be executed to implement the server 102 of FIG. 1 to generate example hyper-parameters 112 in the event the relative loss reduction satisfies a loss threshold.

At block 502, the example server 102 (FIG. 1) updates the hyper-parameter probability distribution (e.g., the hyper-parameter probability distribution (P)) using the relative loss reduction by increasing the probability of the last sampled hyper-parameter (e.g., at least one of the hyper-parameters in the first set of hyper-parameters). (Block 502). In examples disclosed herein, the hyper-parameter generator 204 (FIG. 2) may, responsive to the model aggregator 206 determining an example relative loss reduction, generate and/or otherwise update the hyper-parameter probability distribution (P) by increasing the probability of at least one of the previously sampled hyper-parameters within the hyper-parameters (H) (e.g., the hyper-parameters 112).

In response, the server 102 generates a second set of hyper-parameters (e.g., the hyper-parameters (H)) using the hyper-parameter probability distribution (e.g., the hyper-parameter probability distribution (P)). (Block 504). In examples disclosed herein, the hyper-parameter generator 204 generates the second set of hyper-parameters (H) using the hyper-parameter probability distribution (P).

At block 506, the server 102 transmits the aggregate model and second set of hyper-parameters to the clients 104, 106, 108. (Block 506). In examples disclosed herein, the interface 202 (FIG. 2) transmits the second set of hyper-parameters (H) to the clients 104, 106, 108.

At block 508, the server 102 determines whether to continue operating. (Block 508). In examples disclosed herein, the server 102 may determine to continue operating in the event additional training rounds are desired. Alternatively, the server 102 may determine not to continue operating in the event additional training rounds are not desired. In examples disclosed herein, in the event the server 102 determines to continue operating (e.g., the control of block 508 returns a result of YES), the process returns to block 408 of FIG. 4. Alternatively, in the event the server 102 determines not to continue operating (e.g., the control of block 508 returns a result of NO), the process stops.

FIG. 6 is a flowchart representative of example machine readable instructions 600 which may be executed to implement the server 102 of FIG. 1 to generate example hyper-parameters 112 in the event the relative loss reduction does not satisfy a loss threshold.

At block 602, the example server 102 (FIG. 1) updates the hyper-parameter probability distribution (e.g., the hyper-parameter probability distribution (P)) using the relative loss reduction by decreasing the probability of the last sampled hyper-parameter (e.g., at least one of the hyper-parameters in the first set of hyper-parameters). (Block 602). In examples disclosed herein, the hyper-parameter generator 204 (FIG. 2) may, responsive to the model aggregator 206 determining an example relative loss reduction, generate and/or otherwise update the hyper-parameter probability distribution (P) by decreasing the probability of at least one of the previously sampled hyper-parameters within the hyper-parameters (H) (e.g., the hyper-parameters 112).

In response, the server 102 generates a second set of hyper-parameters (e.g., the hyper-parameters (H)) using the hyper-parameter probability distribution (e.g., the hyper-parameter probability distribution (P)). (Block 604). In examples disclosed herein, the hyper-parameter generator 204 generates the second set of hyper-parameters (H) using the hyper-parameter probability distribution (P).

At block 606, the server 102 transmits the aggregate model and second set of hyper-parameters to the clients 104, 106, 108. (Block 606). In examples disclosed herein, the interface 202 (FIG. 2) transmits the second set of hyper-parameters (H) to the clients 104, 106, 108.

At block 608, the server 102 determines whether to continue operating. (Block 608). In examples disclosed herein, the server 102 may determine to continue operating in the event additional training rounds are desired. Alternatively, the server 102 may determine not to continue operating in the event additional training rounds are not desired. In examples disclosed herein, in the event the server 102 determines to continue operating (e.g., the control of block 608 returns a result of YES), the process returns to block 408 of FIG. 4. Alternatively, in the event the server 102 determines not to continue operating (e.g., the control of block 608 returns a result of NO), the process stops.

FIG. 7 is a block diagram of an example processor platform 700 structured to execute the instructions of FIG. 3 to implement the model trainer 118 of FIG. 1. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 700 of the illustrated example includes a processor 712. The processor 712 of the illustrated example is hardware. For example, the processor 712 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example model trainer 118 of FIG. 1.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), a Bluetooth® interface, a near field communication (NFC) interface, and/or a PCI express interface.

In the illustrated example, one or more input devices 722 are connected to the interface circuit 720. The input device(s) 722 permit(s) a user to enter data and/or commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 720 of the illustrated example, thus, typically includes a graphics driver card, a graphics driver chip, and/or a graphics driver processor.

The interface circuit 720 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 726. The communication can be via, for example, an Ethernet connection, a digital subscriber line (DSL) connection, a telephone line connection, a coaxial cable system, a satellite system, a line-of-site wireless system, a cellular telephone system, etc.

The processor platform 700 of the illustrated example also includes one or more mass storage devices 728 for storing software and/or data. Examples of such mass storage devices 728 include floppy disk drives, hard drive disks, compact disk drives, Blu-ray disk drives, redundant array of independent disks (RAID) systems, and digital versatile disk (DVD) drives.

The machine executable instructions 732 of FIG. 3 may be stored in the mass storage device 728, in the volatile memory 714, in the non-volatile memory 716, and/or on a removable non-transitory computer readable storage medium such as a CD or DVD.

The processor platform 700 of the illustrated example of FIG. 7 includes an example graphic processing unit (GPU) 740, an example vision processing unit (VPU) 742, and an example neural network processor 744. In this example, the GPU 740, the VPU 742, and the neural network processor 744 are in communication with different hardware of the processing platform 700, such as the volatile memory 714, the non-volatile memory 716, etc., via the bus 718. In this example, the neural network processor 744 can be implemented by one or more integrated circuits, logic circuits, microprocessors, GPUs, DSPs, or controllers from any desired family or manufacturer that can be used to execute an AI model, such as a neural network. In some examples, the model trainer 118 can be implemented in or with at least one of the GPU 740, the VPU 742, or the neural network processor 744 instead of or in addition to the processor 712.

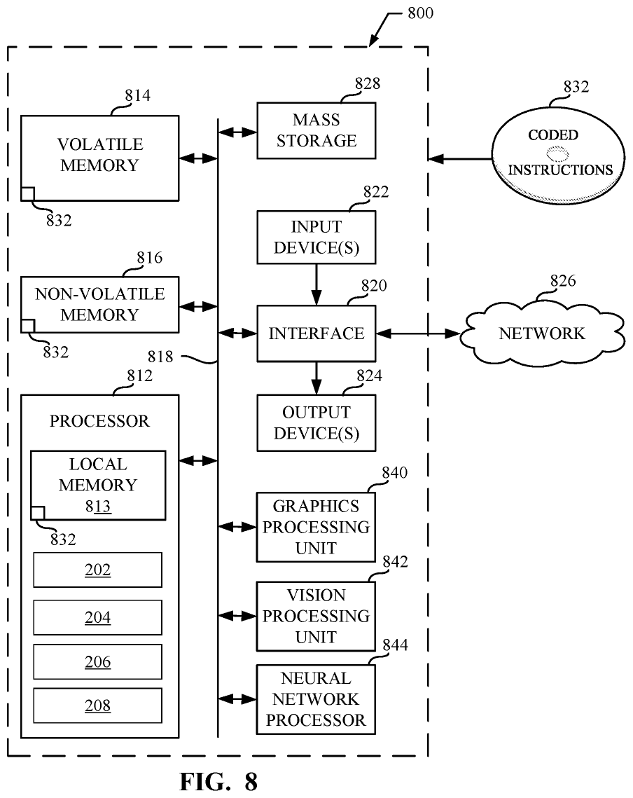

FIG. 8 is a block diagram of an example processor platform 800 structured to execute the instructions of FIGS. 4, 5, and/or 6 to implement the server 102 of FIG. 1. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 800 of the illustrated example includes a processor 812. The processor 812 of the illustrated example is hardware. For example, the processor 812 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example interface 202, the example hyper-parameter generator 204, the example model aggregator 206, and/or the example data store 208.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), a Bluetooth® interface, a near field communication (NFC) interface, and/or a PCI express interface.

In the illustrated example, one or more input devices 822 are connected to the interface circuit 820. The input device(s) 822 permit(s) a user to enter data and/or commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 820 of the illustrated example, thus, typically includes a graphics driver card, a graphics driver chip, and/or a graphics driver processor.

The interface circuit 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

The processor platform 800 of the illustrated example also includes one or more mass storage devices 828 for storing software and/or data. Examples of such mass storage devices 828 include floppy disk drives, hard drive disks, compact disk drives, Blu-ray disk drives, redundant array of independent disks (RAID) systems, and digital versatile disk (DVD) drives.

The machine executable instructions 832 of FIGS. 4, 5, and/or 6 may be stored in the mass storage device 828, in the volatile memory 814, in the non-volatile memory 816, and/or on a removable non-transitory computer readable storage medium such as a CD or DVD.

The processor platform 800 of the illustrated example of FIG. 8 includes an example graphic processing unit (GPU) 840, an example vision processing unit (VPU) 842, and an example neural network processor 844. In this example, the GPU 840, the VPU 842, and the neural network processor 844 are in communication with different hardware of the processing platform 800, such as the volatile memory 814, the non-volatile memory 816, etc., via the bus 818. In this example, the neural network processor 844 can be implemented by one or more integrated circuits, logic circuits, microprocessors, GPUs, DSPs, or controllers from any desired family or manufacturer that can be used to execute an AI model, such as a neural network. In some examples, any of the example interface 202, the example hyper-parameter generator 204, the example model aggregator 206, and/or the example data store 208 can be implemented in or with at least one of the GPU 840, the VPU 842, or the neural network processor 844 instead of or in addition to the processor 812.

From the foregoing, it will be appreciated that example methods, apparatus and articles of manufacture have been disclosed that train a machine learning model across multiple computing devices (e.g., computers, servers, etc.) corresponding to multiple data owners (the “federation”). Examples disclosed herein (a) reduce communication between clients and (b) reduce the number of interactions to train a model by utilizing include a server to select hyper-parameters at the beginning of each round to be sent to the clients. The disclosed methods, apparatus and articles of manufacture improve the efficiency of using a computing device by selecting hyper-parameters using a probability distribution corresponding to the space of all possible values of the hyper-parameters and, updated such a probability distribution based on a relative loss reduction. The disclosed methods, apparatus and articles of manufacture are accordingly directed to one or more improvement(s) in the functioning of a computer.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

Example methods, apparatus, systems, and articles of manufacture to train a machine learning model are disclosed herein. Further examples and combinations thereof include the following:

Example 1 includes an apparatus to generate adaptive hyper-parameters, the apparatus comprising a model aggregator to, in response to obtaining at least one model trained using a first set of hyper-parameters of a probability distribution, generate a loss reduction, and a hyper-parameter generator to when the loss reduction satisfies a loss threshold, update the probability distribution, and generate a second set of hyper-parameters using the updated probability distribution, and an interface to transmit the second set of hyper-parameters to a client.

Example 2 includes the apparatus of example 1, wherein the hyper-parameter generator is to update the probability distribution by increasing a probability of the first set of hyper-parameters.

Example 3 includes the apparatus of example 1, wherein the hyper-parameter generator is to, when the loss reduction does not satisfy the loss threshold, update the probability distribution by decreasing a probability of the first set of hyper-parameters, the loss threshold being a predetermined value.

Example 4 includes the apparatus of example 1, wherein the interface is to send the second set of hyper-parameters to a second client.

Example 5 includes the apparatus of example 1, wherein the interface is to obtain a first loss of the at least one model, and obtain a second loss of a second model trained using the second set of hyper-parameters.

Example 6 includes the apparatus of example 5, wherein the loss reduction is generated based on the first loss and the second loss.

Example 7 includes the apparatus of example 1, wherein the hyper-parameter generator is to generate the probability distribution including at least the first set of hyper-parameters, the first set of hyper-parameters including at least one of a number of optimization steps to perform during a round of training or a learning rate.

Example 8 includes a non-transitory computer readable medium comprising instructions which, when executed, cause at least one processor to in response to obtaining at least one model trained using a first set of hyper-parameters of a probability distribution, generate a loss reduction, when the loss reduction satisfies a loss threshold, update the probability distribution, generate a second set of hyper-parameters using the updated probability distribution, and transmit the second set of hyper-parameters to a client.

Example 9 includes the non-transitory computer readable medium of example 8, wherein the instructions, when executed, cause the at least one processor to update the probability distribution by increasing a probability of the first set of hyper-parameters.

Example 10 includes the non-transitory computer readable medium of example 8, wherein the instructions, when executed, cause the at least one processor to, when the loss reduction does not satisfy the loss threshold, update the probability distribution by decreasing a probability of the first set of hyper-parameters, the loss threshold being a predetermined value.

Example 11 includes the non-transitory computer readable medium of example 8, wherein the instructions, when executed, cause the at least one processor to send the second set of hyper-parameters to a second client.

Example 12 includes the non-transitory computer readable medium of example 8, wherein the instructions, when executed, cause the at least one processor to obtain a first loss of the at least one model, and obtain a second loss of a second model trained using the second set of hyper-parameters.

Example 13 includes the non-transitory computer readable medium of example 12, wherein the loss reduction is generated based on the first loss and the second loss.

Example 14 includes the non-transitory computer readable medium of example 8, wherein the instructions, when executed, cause the at least one processor to generate the probability distribution including at least the first set of hyper-parameters, the first set of hyper-parameters including at least one of a number of optimization steps to perform during a round of training or a learning rate.

Example 15 includes a method to generate adaptive hyper-parameters, the method comprising in response to obtaining at least one model trained using a first set of hyper-parameters of a probability distribution, generating a loss reduction, when the loss reduction satisfies a loss threshold, updating the probability distribution, generating a second set of hyper-parameters using the updated probability distribution, and transmitting the second set of hyper-parameters to a client.

Example 16 includes the method of example 15, further including updating the probability distribution by increasing a probability of the first set of hyper-parameters.

Example 17 includes the method of example 15, further including, when the loss reduction does not satisfy the loss threshold, updating the probability distribution by decreasing a probability of the first set of hyper-parameters, the loss threshold being a predetermined value.

Example 18 includes the method of example 15, further including sending the second set of hyper-parameters to a second client.

Example 19 includes the method of example 15, further including obtaining a first loss of the at least one model, and obtaining a second loss of a second model trained using the second set of hyper-parameters.

Example 20 includes the method of example 19, wherein the loss reduction is generated based on the first loss and the second loss.

The following claims are hereby incorporated into this Detailed Description by this reference, with each claim standing on its own as a separate embodiment of the present disclosure.

What is claimed is:

1. An apparatus to generate adaptive hyper-parameters, the apparatus comprising:
a model aggregator to, in response to obtaining at least one model trained using a first set of hyper-parameters of a probability distribution, generate a loss reduction; and
a hyper-parameter generator to:
when the loss reduction satisfies a loss threshold, update the probability distribution; and
generate a second set of hyper-parameters using the updated probability distribution; and
an interface to transmit the second set of hyper-parameters to a client.

2. The apparatus of claim 1, wherein the hyper-parameter generator is to update the probability distribution by increasing a probability of the first set of hyper-parameters.

3. The apparatus of claim 1, wherein the hyper-parameter generator is to, when the loss reduction does not satisfy the loss threshold, update the probability distribution by decreasing a probability of the first set of hyper-parameters, the loss threshold being a predetermined value.

4. The apparatus of claim 1, wherein the interface is to send the second set of hyper-parameters to a second client.

5. The apparatus of claim 1, wherein the interface is to:
obtain a first loss of the at least one model; and
obtain a second loss of a second model trained using the second set of hyper-parameters.

6. The apparatus of claim 5, wherein the loss reduction is generated based on the first loss and the second loss.

7. The apparatus of claim 1, wherein the hyper-parameter generator is to generate the probability distribution including at least the first set of hyper-parameters, the first set of hyper-parameters including at least one of a number of optimization steps to perform during a round of training or a learning rate.

8. A non-transitory computer readable medium comprising instructions which, when executed, cause at least one processor to:
in response to obtaining at least one model trained using a first set of hyper-parameters of a probability distribution, generate a loss reduction;
when the loss reduction satisfies a loss threshold, update the probability distribution;
generate a second set of hyper-parameters using the updated probability distribution; and
transmit the second set of hyper-parameters to a client.

9. The non-transitory computer readable medium of claim 8, wherein the instructions, when executed, cause the at least one processor to update the probability distribution by increasing a probability of the first set of hyper-parameters.

10. The non-transitory computer readable medium of claim 8, wherein the instructions, when executed, cause the at least one processor to, when the loss reduction does not satisfy the loss threshold, update the probability distribution by decreasing a probability of the first set of hyper-parameters, the loss threshold being a predetermined value.

11. The non-transitory computer readable medium of claim 8, wherein the instructions, when executed, cause the at least one processor to send the second set of hyper-parameters to a second client.

12. The non-transitory computer readable medium of claim 8, wherein the instructions, when executed, cause the at least one processor to:
obtain a first loss of the at least one model; and
obtain a second loss of a second model trained using the second set of hyper-parameters.

13. The non-transitory computer readable medium of claim 12, wherein the loss reduction is generated based on the first loss and the second loss.

14. The non-transitory computer readable medium of claim 8, wherein the instructions, when executed, cause the at least one processor to generate the probability distribution including at least the first set of hyper-parameters, the first set of hyper-parameters including at least one of a number of optimization steps to perform during a round of training or a learning rate.

15. A method to generate adaptive hyper-parameters, the method comprising:
in response to obtaining at least one model trained using a first set of hyper-parameters of a probability distribution, generating a loss reduction;
when the loss reduction satisfies a loss threshold, updating the probability distribution;
generating a second set of hyper-parameters using the updated probability distribution; and
transmitting the second set of hyper-parameters to a client.

16. The method of claim 15, further including updating the probability distribution by increasing a probability of the first set of hyper-parameters.

17. The method of claim 15, further including, when the loss reduction does not satisfy the loss threshold, updating the probability distribution by decreasing a probability of the first set of hyper-parameters, the loss threshold being a predetermined value.

18. The method of claim 15, further including sending the second set of hyper-parameters to a second client.

19. The method of claim 15, further including:
obtaining a first loss of the at least one model; and
obtaining a second loss of a second model trained using the second set of hyper-parameters.

20. The method of claim 19, wherein the loss reduction is generated based on the first loss and the second loss.
